(19) United States
(12) Patent Application Publication
(10) Pub. No.: US 2010/0042548 A1
(43) Pub. Date: Feb. 18, 2010

(54) Method and System for Obtaining An Invoice Outsourcing Agreement

(75) Inventors: Denise L. Conrad, Endwell, NY (US); James D. Episale, Binghamton, NY (US)

Correspondence Address: Weitzman Law Offices LLC, 425 Eagle Rock Avenue, Suite 102, Roseland, NJ, 07068, US

(73) Assignee: INTERNATIONAL BUSINESS MACHINES CORPORATION, Armonk, NY (US)

(21) Appl. No.: 12/190,180

(22) Filed: Aug. 12, 2008

(51) Int. Cl. G06Q 30/00; G06Q 10/00

(52) U.S. Cl. 705/80

(57) ABSTRACT

A computer-implemented method for electronically obtaining an agreement authorizing a digital signature prior to invoicing to comply with a regulation in a tax jurisdiction. The method comprises associating a set of suppliers with a user and retrieving from a database a set of buying companies associated with the user's set of suppliers. A list of purchasing tax countries associated with the retrieved set of buying companies is created by querying the database. A list of tax countries associated with the retrieved set of buying companies is created by querying the database. A country-to-country relationship database table is configured to identify purchasing tax country and tax country relationships that require the agreement authorizing a digital signature prior to invoicing. The country-to-country relationship database table is queried for any combination of purchasing tax country and tax country from the lists of purchasing tax countries and tax countries that requires the agreement authorizing a digital signature prior to invoicing. The user is electronically presented with the agreement if any combination of purchasing tax country and tax country from the lists of purchasing tax countries and tax countries requires the agreement authorizing a digital signature prior to invoicing. Acceptance of the agreement by the user is confirmed before an invoice is created involving a purchasing tax country and tax country relationship that requires the agreement authorizing a digital signature prior to invoicing.

### BACKGROUND

1. Field of the Invention

This disclosure relates generally to electronic business documents, and more particularly, to a system and method to automatically obtain a required invoice outsourcing agreement (“IOA”) for electronic signatures prior to the creation of an invoice.

2. Background

When purchasers or sellers record transactions in an electronic purchasing system, they create records or documents, such as purchase orders and invoices. These documents must frequently comply with specific governmental requirements, especially when they relate to international transactions. For example, to remain compliant with tax invoicing directives of the European Union (“EU”), there must be a legal agreement in place between the parties in order to implement advanced electronic or digital signatures. The countries involved in the transaction, either the country where the seller is registered to do business or the country of the purchaser, determine which invoices require digital signatures.

The EU describes this requirement in Council Directive 2001/15/EC. This directive requires that any seller who is subject to a tax, specifically an indirect tax such as a Value Added Tax (“VAT”), ensure that invoices are issued for all goods and services supplied by that seller. The invoice may be issued by the seller, the buyer, or a third party on behalf of the seller. Invoices may be prepared or created by the customer of the seller on condition that there is an agreement between the two parties at the outset and there is a procedure to accept the invoice. This directive also allows for the use of electronic means and specifies that an advanced electronic signature must be used to provide authenticity of the origin and integrity of the contents.

The EU defines advanced electronic signature in Directive 1999/93/EC. In Annex 11(k), the EU again specifies that information concerning the terms and conditions regarding certification of electronic signatures must be communicated prior to a contractual relationship for the use of advanced electronic signatures. This Directive allows for electronic transmission of the information.

With the proliferation of global commerce, one supplier may be registered in multiple jurisdictions, both EU member states as well as non-EU jurisdictions. Some non-EU entities may acquire EU VAT registration numbers in one or more EU member states and, therefore, be treated as a EU entity for VAT purposes. Conversely, a purchaser or buying party may receive invoices from a worldwide seller base where goods transfer between various jurisdictions. Although the purchaser may be located in a country that is not under a VAT regime, the business entity may have VAT registration in multiple jurisdictions.

Given the complexity of the situation, any one supplier may be subject to the EU directives or other governmental regulations for one type of transaction and not another, depending on the whether the supplier chooses or is required to do business under a particular VAT registration and whether the purchaser is also subject to the VAT. Driving the requirement for compliance with the EU directives is the combination of the two specific countries involved in the specific transaction and not based on a buyer and a seller generally. This requires a flexible electronic purchasing system that recognizes whether a particular transaction is subject to the EU directives or other governmental regulations requiring a digital signature.

### BRIEF SUMMARY

In one aspect of this application, a computer-implemented method is disclosed for electronically obtaining an agreement authorizing a digital signature prior to invoicing to comply with a regulation in a tax jurisdiction. The method comprises associating a set of suppliers with a user and retrieving from a database a set of buying companies associated with the user's set of suppliers. A list of purchasing tax countries associated with the retrieved set of buying companies is created by querying the database. A list of tax countries associated with the retrieved set of buying companies is created by querying the database. A country-to-country relationship database table is configured to identify purchasing tax country and tax country relationships that require the agreement authorizing a digital signature prior to invoicing. The country-to-country relationship database table is queried for any combination of purchasing tax country and tax country from the lists of purchasing tax countries and tax countries that requires the agreement authorizing a digital signature prior to invoicing. The user is electronically presented with the agreement if any combination of purchasing tax country and tax country from the lists of purchasing tax countries and tax countries requires the agreement authorizing a digital signature prior to invoicing. Acceptance of the agreement by the user is confirmed before an invoice is created involving a purchasing tax country and tax country relationship that requires the agreement authorizing a digital signature prior to invoicing.

The foregoing has outlined rather generally the features and technical advantages of one or more embodiments of this disclosure in order that the following detailed description may be better understood. Additional features and advantages of this disclosure will be described hereinafter, which may form the subject of the claims of this application.

### BRIEF DESCRIPTION OF THE DRAWINGS

This disclosure is further described in the detailed description that follows, with reference to the drawings, in which:

FIG. 1 illustrates an illustrative computer implementation of a system for obtaining acceptance of an IOA prior to creating an invoice requiring a digital signature;

FIG. 2 illustrates a preferred flow diagram of a logon sequence for obtaining acceptance of an IOA prior to creating an invoice requiring a digital signature; and

FIG. 3 illustrates a preferred flow diagram for presenting an IOA and generating an invoice.

### DETAILED DESCRIPTION

This application discloses a preferred system and process for automatically presenting and obtaining acceptance of a required agreement between trading partners (e.g., buyer and seller) prior to a partner generating a document (e.g., an invoice) in an electronic purchasing system. In one embodiment, the system requires a user to approve an agreement to use electronic or digital signatures (e.g., an invoice outsourcing agreement (“IOA”)) prior to being permitted to create invoices in the purchasing system where a digital signature is required for that particular invoice.

While the system and method disclosed herein may be utilized to ensure compliance with EU directives, it is understood that the disclosed system and method is not limited to transactions implicating EU VAT and may be implemented to obtain an IOA to comply with the laws or regulation of other jurisdictions as well.

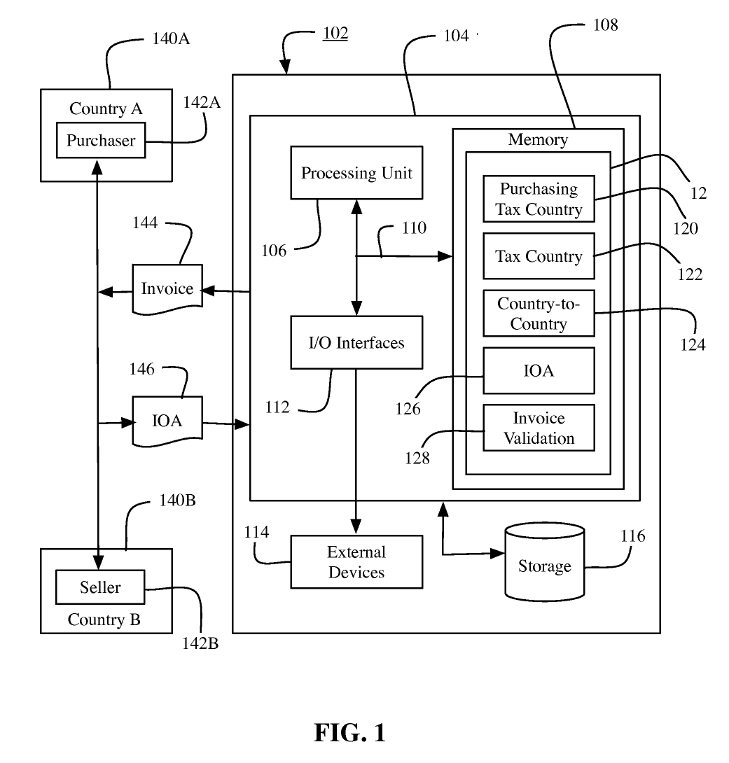

Referring to FIG. 1, an illustrative computer-implemented system 102 is shown for obtaining acceptance of an IOA prior to creating an invoice requiring a digital signature. The system 102 includes a computer system 104 deployed that may be implemented within a network environment, including, but not limited to, the Internet, a wide area network (“WAN”), a local area network (“LAN”), a virtual private network (“VPN”), or to a stand-alone computer system.

Computer system 104 preferably includes a processing unit 106, a memory 108, a bus 110, and input/output (“I/O”) interfaces 112 in communication with external I/O devices 114 and storage system 116. In general, processing unit 106 executes computer program code, such as IOA processing system 12, which is stored in memory 108 and/or storage device 116. While executing computer program code, processing unit 106 can read and write data to/from memory 108, storage system 116 and/or I/O interfaces 112. Bus 110 provides a communication link between each of the components in the computer system 104. External devices or interfaces 114 may include any device (e.g., keyboard, pointing device, display, etc.) that enables a user to interact with the computer system 104 and/or any devices (e.g., network card, modem, etc.) that enables the computer system 104 to communication with one or more other computing devices.

The storage system 116 may be any type of system (e.g., a database) capable of providing storage for information under the present disclosure, such as, for example, electronic invoices, electronic purchase orders, sets of rules, and/or computations/determinations made by the IOA processing system 12.

The IOA processing system 12 is preferably stored in memory 108. The IOA processing system 12 preferably includes a purchasing tax country determination system 120, a tax country determination system 122, a country-to-country relationship determination system 124, an IOA acceptance system 126, and an invoice validation system 128.

FIG. 1 illustrates an exemplary transaction occurring between a purchaser 142A in jurisdiction “A” (purchaser tax country) 140A and a seller 142B in jurisdiction “B” (tax country) 140B. Seller 142B may access the system 102 in a conventional manner to create an invoice 144. Purchasing tax country determination system 120 retrieves a distinct list of purchaser tax countries associated with seller 142B. Tax country determination system 122 retrieves a distinct list of tax countries associated with seller 142B from memory 108 and/or storage device 116. Using this retrieved list of countries, the system 102 queries the country-to-country relationship determination system 124 to determine whether there is a combination of tax country and purchasing tax country that requires an IOA. If the country relationship determination system 124 determines that an IOA is required, the IOA acceptance system 126 presents the agreement and stores the acceptance of an IOA 146 or non-acceptance of the agreement. The invoice validation system 128 makes a determination whether a required IOA is available in the IOA acceptance system 126 before a new invoice 144 requiring a digital signature is allowed to be completed.

In operation, if a user of the system 102 has the capability to create an invoice that involves the EU (or some other jurisdiction), and that invoice needs to be digitally signed, the system 102 will automatically present user with an IOA 146 during logon to the system and will require the user to accept the IOA before an invoice 144 can be created that involves a tax country and a purchasing tax country relationship within the EU. In the event that the user does not accept the IOA 146, the user may still be permitted access to the system 102 to create other documents such as purchase orders or view the status of transactions. Non-acceptance of the IOA 146 preferably only prevents the user from creating invoices that fall under the EU directives or other governmental regulations requiring acceptance of the IOA for advanced electronic signatures (e.g., invoices that need to be digitally signed).

Once the user accepts the IOA 146, the system 102 grants the user access to create an invoice 144. Prior to issuing the invoice 144, the system 102 determines whether the IOA 146 has been accepted by the user on this or on a previous logon. If the IOA 146 has been accepted, the system 102 issues the invoice 144. If the IOA 146 has not been accepted by the user either on this or on a previous logon, the system 102 precludes creation of an invoice 144 that includes a tax country and purchasing country relationship with the EU or other countries/jurisdictions requiring the invoice 144 to be digitally signed. Instead, the system 102 displays a message that an invoice cannot be generated without acceptance of the IOA 146.

If the user does not accept the IOA 146, the system 102 may permit the user to enter the purchasing system to view previous records, such as purchase orders and issued invoices, and to check the status of various transactions. If the user attempts to create an invoice, the system 102 will determine that the user did not execute an IOA 146 on this or previous logons, displays a message that an invoice cannot be generated without acceptance of the IOA 146.

The preferred process to determine when the IOA 146 is initially presented to the user is preferably determined by the country relationships associated with a particular user. A user is a person who creates invoices in the system 102 and may be, for example, but not limited to, a seller or supplier of goods and services, a third party representative of the seller, or other individuals authorized to create invoices. The user may be initially set up in the system 102 to be associated with one or more buying companies. The user may also be set up with one or more tax identification registration numbers, depending on which jurisdiction(s) the seller is doing business in. This may include VAT registration numbers for the EU (or some other jurisdiction). The user may be associated with tax countries based on the tax registration numbers. The tax countries associated with the user are preferably stored in memory 108 and/or database 116 of the system 102.

The buying company 142A is the purchaser of goods and services and may be, for example, but not limited to, one company, a company with multiple subsidiaries, a purchasing consortium with multiple members, third party representatives of purchasers, or other individuals who are authorized to use the purchasing system. The purchaser or buying company is associated with a purchasing tax country in the memory 108 and/or database 116 of the purchasing system 102.

The system 102 preferably includes a database table that stores the relationship between two countries: the purchasing tax country and the tax country. Based on this country relationship, a new column in the database table indicates whether or not the IOA 146 needs to have been accepted in order to use electronic signatures on invoices. This column may contain one or more predefined domain values that identify whether or not the IOA 146 is required and should initially be displayed for acceptance by the user. The predefined domain values may be, for example, “Yes” indicating that the IOA is needed or “No” indicating that the IOA is not needed.

When the user logs into the system 102, the system determines whether the user has the ability to create an invoice where the purchasing tax country or the tax country for the invoice is a country within, for example, the EU. If a EU country is either the purchasing tax country or tax country, or both, the system 102 will require the user to accept the IOA 146 before generating an invoice 144. This relationship is configured in the database table. Once the user accepts or rejects the IOA 146, it is recorded or otherwise stored in the database that the action was taken.

To determine the list or set of purchasing tax countries that a user may use, the system 102 obtains the set of buying companies that the suppliers associated with the particular user has a relationship. A user may represent one or more suppliers. The set of buying companies preferably does not contain any company that is blocked or logically deleted. A block or logical deletion indicates that the buying company may not do business with the selling company for reasons such as it is no longer approved or for other business reasons not related to IOA. The set of buying companies is obtained by retrieving from the database the distinct list of buying companies associated with the user's set of suppliers, excluding those that are blocked.

Using this set of buying companies, the system 102 executes a query in the database to determine the distinct set of purchasing tax countries that are associated with this list or set of buying companies. If the query does not return any rows from the database, then invoicing is not allowed and an IOA is not needed, and the user may continue to enter the system 102.

To determine the list or set of tax countries that user may use, the system 102 preferably starts with the distinct set of buying companies that the suppliers associated with the particular user has a relationship. The set of buying companies does not contain any company that is blocked or logically deleted. Using this set of buying companies, the system 102 queries the database to determine whether a particular buying company is a candidate for EU invoicing. If the value for this buying company indicates that an invoice can be created for a company with more than one VAT number, then the list or set of possible tax countries will be generated based on the possible tax countries associated with this buying company. If a buying company does not support EU invoicing, the list of possible tax countries will be generated by looking at the set of countries where the supplier has a VAT registration number. If the query does not return any rows from the database, then invoicing is not allowed and an IOA is not needed, and the user may continue to enter the system 102.

Using the sets of possible purchasing tax countries and tax countries associated with the user, the system 102 determines if an IOA 146 needs to be displayed. The system 102 queries the database for each combination of purchasing tax country and tax country. If there is a least one combination that requires an IOA 146, then the IOA needs to be presented to the user. If the predefined domain value in the column in the database table is “Yes,” the IOA 146 needs to be accepted before an invoice 144 can be created for this particular country-to-country combination. If the predefined domain value in the column in the database table is “No,” the IOA 146 does not need to be accepted before an invoice 144 can be created for this particular combination.

If the IOA 146 is to be accepted by the user, the first screen shown to the user by the system 102 is the IOA screen that has the legal text of the agreement. The system 102 presents the user with the choice to continue or to not accept the IOA 146. If the user chooses to continue, the system 102 will present the user with a Confirmation Accept screen. From here, if the user chooses “Accept,” the user will be brought to the Welcome screen of the system 102 and into the invoicing application. If the user chooses “Cancel,” the system 102 will return the user to the IOA screen.

If the user chooses not to accept on the IOA screen, the system 102 will request that the user confirm the decision not to accept the IOA. If the user chooses to not accept, the user will be brought to the Welcome screen of the system 102 and into the invoicing application. The system 102, however, will prevent the user from creating an invoice that requires a digital signature. If the user attempts to create an invoice that requires a digital signature, the system 102 will return the user back to the IOA screen.

During creation of any invoice 144, the system 102 queries the database to determine if the particular purchasing tax country and tax country combination require an IOA 146 and if the user had accepted the IOA either during this logon session or other previous sessions. If the predefined domain value in the column of the database table is “Yes,” the IOA 146 needs to be accepted before an invoice 144 can be created for this particular country-to-country combination. If the user has not accepted the IOA 146, the system 102 displays a message that an invoice cannot be generated without acceptance of the IOA 146.

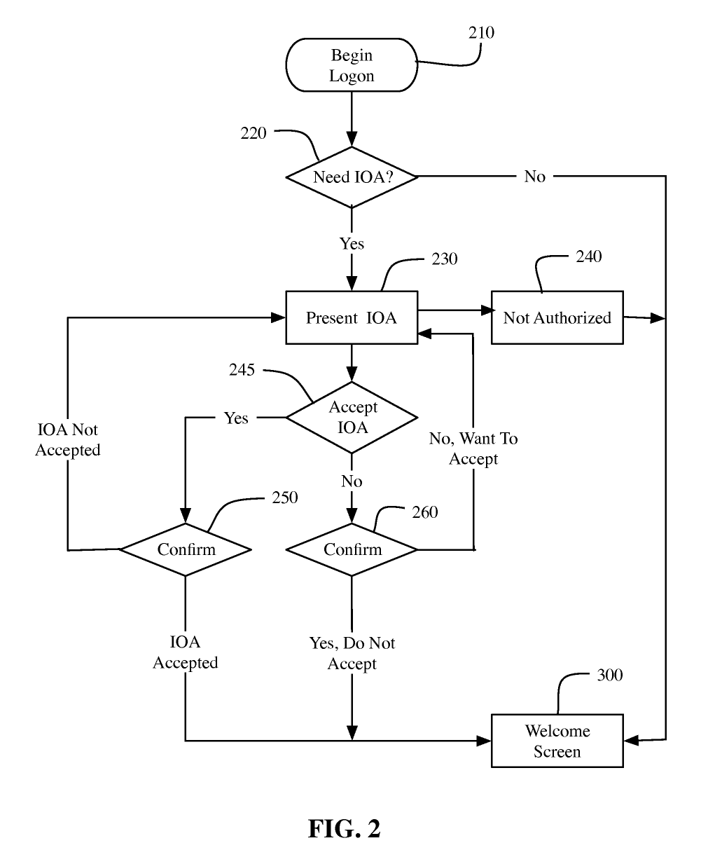

FIG. 2 illustrates a preferred flow diagram of an invoicing system logon sequence for obtaining acceptance of an IOA 146 prior to creating an invoice 144 requiring a digital signature. The user begins the logon process at step 210 and the system 102 determines whether he must accept the IOA at step 220. If NO, or if user had previously accepted the latest IOA, the system 102 presents the user with the Welcome Screen in step 300. If the user's role does not include creating invoices, then the user is deemed not authorized in step 240 and the system 102 directs the user to the Welcome Screen in step 300.

If the determination in step 220 is YES, the user is presented with the IOA 146 in step 230. In step 245, the system 102 offers the user a choice whether or not to accept the IOA 146. If the user accepts the IOA in step 245, the system offers the user a choice to confirm or cancel in step 250. If the user confirms acceptance of the IOA in step 250, the system 102 presents the user with the Welcome Screen in step 300. If the user cancels the acceptance of the IOA in step 250, the system directs the user back to the IOA acceptance screen in step 230.

If the user initially does not accept the IOA 146 in step 245, the system 102 requests that the user choose whether or not to confirm non-acceptance of the IOA in step 260. If user confirms non-acceptance, the system presents the user with the Welcome Screen in step 300. If the user cancels non-acceptance of the IOA in step 260, the system 102 returns the user to the IOA acceptance screen in step 230.

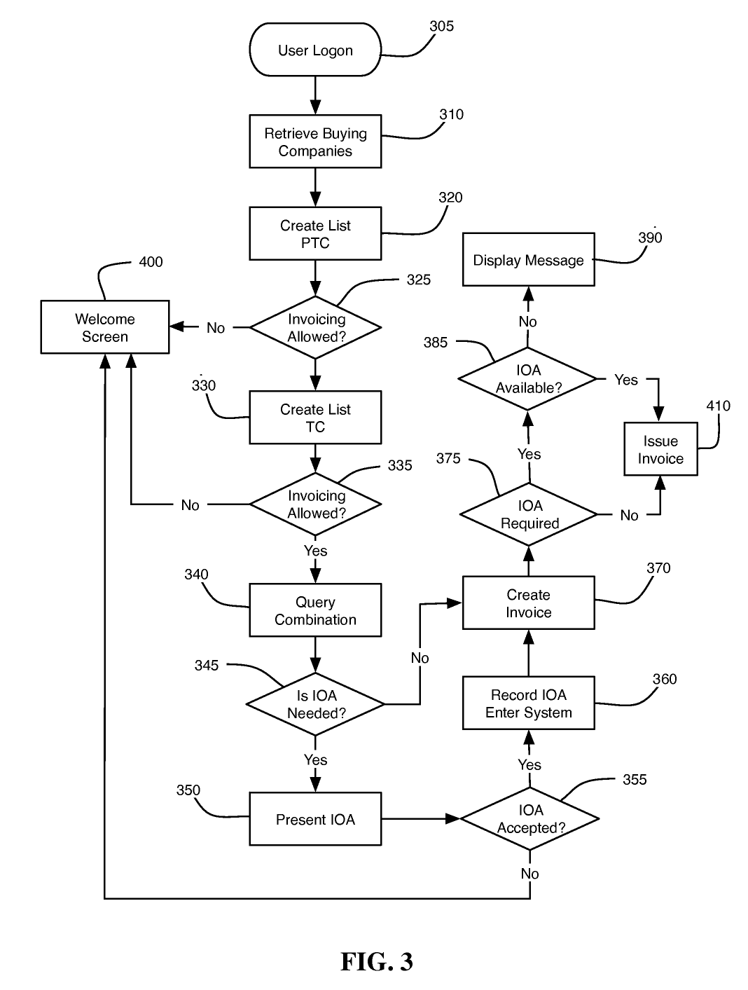

FIG. 3 illustrates a preferred flow diagram for presenting an IOA 146 and generating an invoice 144 using the system 102. When the user initiates the logon process to the system 102 in step 305, the system 102 retrieves the unique list of buying companies associated with the user in step 310. In step 320, the system 102 queries the database and creates a set of purchasing tax countries (“PTC”).

In step 325, the system 102 determines if invoicing is allowed to proceed based on the countries returned in response to the PTC query. If invoicing is not allowed, the system returns the user to the welcome screen in step 400 and permits the user to perform other tasks that are allowed.

If invoicing is allowed to proceed in step 325, the system 102 queries the database and creates a list of tax countries (“TC”) in step 330. In step 335, the system determines if invoicing is allowed to proceed by whether any countries are returned in response to the TC query. If invoicing is not allowed to proceed in step 335, the system returns the user to the welcome screen in step 400 and permits the user to perform other tasks that are allowed.

If invoicing is allowed to proceed in step 335, the system 102 queries the database for each combination of countries from the PTC and TC lists created in steps 320 and 330 in a county-to-country database table in step 340. If an IOA 146 is not needed for this transaction in step 345, the system 102 allows the user to create an invoice 144 in step 370.

Alternatively, if the response to the query of the country-to-country database table produces in step 345 is affirmative that an IOA 146 is needed, the system 102 presents the user with an IOA 146 in step 350. If the IOA 146 presented to the user is not accepted in step 355, the system returns the user to the welcome screen in step 400.

If the IOA is accepted in step 355, the accepted IOA 146 is recorded and/or stored, and the user is permitted to enter the system in step 360. Thereafter, the user may create an invoice in step 370. In step 375, the system 102 determines whether an IOA 146 is required for the particular invoice being created by the user. If an IOA is not required in step 375, then the system issues the invoice in step 410. If an IOA is required in step 375, then the system confirms that an IOA 146 has been accepted in step 385. If an IOA has been accepted, the system issues the invoice in step 410. If an IOA has not been accepted, displays a message that an invoice cannot be generated without acceptance of the IOA in step 390.

Having described and illustrated the principles of this application by reference to one or more preferred embodiments, it should be apparent that the preferred embodiment(s) may be modified in arrangement and detail without departing from the principles disclosed herein and that it is intended that the application be construed as including all such modifications and variations insofar as they come within the spirit and scope of the subject matter disclosed herein.

What is claimed is:

1. A computer-implemented method for electronically obtaining an agreement authorizing a digital signature prior to invoicing to comply with a regulation in a tax jurisdiction, comprising:
associating a set of suppliers with a user;
retrieving from a database a set of buying companies associated with the user's set of suppliers;
querying the database to create a list of purchasing tax countries associated with the retrieved set of buying companies;
querying the database to create a list of tax countries associated with the retrieved set of buying companies;
configuring a country-to-country relationship database table to identify purchasing tax country and tax country relationships that require the agreement authorizing a digital signature prior to invoicing;
querying the country-to-country relationship database table for any combination of purchasing tax country and tax country from the lists of purchasing tax countries and tax countries that requires the agreement authorizing a digital signature prior to invoicing;
electronically presenting the user with the agreement if any combination of purchasing tax country and tax country from the lists of purchasing tax countries and tax countries requires the agreement authorizing a digital signature prior to invoicing; and
confirming that the user has accepted the agreement before an invoice is created involving a purchasing tax country and tax country relationship that requires the agreement authorizing a digital signature prior to invoicing.
